(19) United States
(12) Patent Application Publication
(10) Pub. No.: US 2023/0196882 A1
(43) Pub. Date: Jun. 22, 2023

(54) VIRTUAL SPORTS LEAGUE

(71) Applicant: Amtote International, Inc., Hunt Valley, MD (US)

(72) Inventors: Garrett Biemer, Boston, MA (US); Paul Williams, Boca Raton, FL (US); Zachary Leifer, Las Vegas, NV (US)

(73) Assignee: Amtote International, Inc., Hunt Valley, MD (US)

(21) Appl. No.: 17/554,334

(22) Filed: Dec. 17, 2021

(51) Int. Cl. G07F 17/32; G06Q 30/08; G06Q 20/12; G06Q 50/34

(52) U.S. Cl. CPC G07F 17/3288; G06Q 30/08; G06Q 20/123; G06Q 50/34

(57) ABSTRACT

A method of simulating, on a computer, the activities of a virtual sports league, includes the steps of creating: (a) virtual sports participants, each of which includes a participant statistic that serves to define the performance level of a sports participant, (b) virtual sports teams, each of which has roles for the method's users of virtual team manager, owner, and sports agents, (c) a virtual sports league that includes a season schedule of games between these teams, and (d) formulating the outcome of each of these virtual games to determine the seasonal standings of the teams within the league.

### BACKGROUND OF THE INVENTION

### 1. Field of the Invention

The present invention generally relates to devices, systems and methods pertaining to computer networked games or events. More specifically, the present invention relates to the means and methods for simulating, on a computer, the activities of a virtual sports league for the enjoyment of its users who participate in controlling the activities of such a league and its simulations of team sports events/games.

### 2. Description of the Related Art

Online fantasy or virtual sports games and their methods are popular with fans of a wide variety of sports. The first inventions for these activities appear to have originated in the early 2000s. For example, see USPPN 2007/0293289 where there is disclosed the means for generating fictional or fantasy or virtual sports teams that have simulated sports competitions whose outcomes are based on designated, historical sports data.

The initial roles of those playing these virtual sports games (i.e., game users) included forming one of such virtual sports teams by selecting real-life or real-world players to be virtual members or sports participants of a game user's or user's fantasy sports team. The outcomes of the resulting competitions between the users' virtual sports teams were generally determined by the actions of a user's selected, real-life players in current, designated games.

The opportunities for the users of these fantasy sports games to input into the strategies for these competitions and thereby impact their outcomes were disclosed soon thereafter, see USPPN 2007/0244878. These online games continued to evolve with the disclosure of the means to allow their users to be involved in team formulations (e.g., acquiring sports participants or players), see U.S. Pat. No. 8,052,521.

This was followed by disclosures for the means to allow game users to operate as team owners and impact the game schedules and outcome of the competitions in which the owner's team was participating, see USPPN 2012/0178510.

By 2015, online fantasy sports game disclosures had enabled a game user to operate in a wide range of roles associated with the conduct of fantasy or virtual sports competitions. These roles included the activities of drafting rosters of fantasy sports players to form various teams that compete over a season schedule of games, selecting team lineups for each of these games, and inputting strategies that impacted the schedule's fantasy game outcomes. These continued to be primarily based on the actual performance of the real sportsmen upon whom the fantasy or virtual players were based, see U.S. Pat. Nos. 8,315,722 and 9,427,669, or to be based on historical sports data, see U.S. Pat. Nos. 8,888,584 and 10,918,959. The exception being where the users built a type of stock portfolio and outcomes are based on subsequent stock market related metrics, see U.S. Pat. No. 9,511,284.

Meanwhile, disclosures related to improvements to the graphical representations (i.e., animations) of fantasy sporting events continued to contribute to their growing popularity, see U.S. Pat. No. 8,400,456. More recently, additional disclosures have been made which enable fantasy sports game users to further operate as team owners and undertake still more tasks associated with team ownership; for example: selling portions of the owner's team to investors, see U.S. Pat. No. 10,427,054, and participating in a simulated sports team stock exchange or effectively a futures market for sports teams, see USPPN 2019/0311432.

Despite these advancements in online fantasy sports games, there is still a demand for further improvements that will enhance the entertainment value of these games and thereby increase the number of people that use them. The present invention seeks to provide some of these improvements by expanding the horizons and capabilities of fantasy sports competitions.

### SUMMARY OF THE INVENTION

Recognizing the need for the development of new ways to enhance the entertainment value of online fantasy sports games, the present invention seeks to provide the methods and devices for accomplishing this objective.

In accordance with a preferred embodiment of the present invention, a method of simulating, on a computer, the activities of a virtual sports league, includes the steps of creating: (a) virtual sports participants, each of which includes a participant statistic that serves to define the performance level of a sports participant, (b) virtual sports teams, each of which has roles for the method's users of virtual team manager, owner, and sports agents, (c) a virtual sports league that includes a season schedule of games between these teams, and (d) formulating the outcome of each of these virtual games to determine the seasonal standings of the teams within the league.

In accordance with another obvious variant of the present invention, an auction is used to determine which sports agents represent which sports participants.

In accordance with yet another obvious variant of the present invention, a virtual team owner's negotiations to buy a sports team includes an auction in which the various virtual owners place bids to buy a virtual sports team.

In accordance with still another obvious variant of the present invention, a virtual sports league includes a plurality of hierarchical-ranked, virtual sports leagues including a top-ranked and a bottom-ranked, virtual sports league, and wherein a virtual sports team can, depending on its season-ending standing in its league, advance for the upcoming sports season to play in higher, hierarchical ranked, virtual sports league.

In accordance with a still further obvious variant of the present invention, a means is provided that allows virtual spectators to wager on the outcomes of the virtual games.

Yet another obvious variant of the present invention includes the step of producing video simulations of these virtual games, and a visually representative table of the seasonal standings of the teams in their respective virtual sports leagues.

A still further obvious variant of the present invention is a system for providing a virtual sports league game to a plurality of game users, each having a networked computing device with a display that is used to play this game over a network. This system includes: (1) a server that connects to the network and has a processor with memory, (2) a database that resides in the memory and stores information pertaining to this virtual sports league game, and (3) software that controls the operation of the processor and creates for the virtual sports league game: (i) a plurality of sports in which a game user may select to compete when playing the game, (ii) a plurality of virtual sports participants, each of which includes a participant statistic that serves to define the performance level of the virtual sports participant, (iii) a plurality of virtual sports teams, each of which has a team roster of virtual sport participants, (iv) a plurality of virtual sports leagues that are distinguishable by the level or tier at which the selected sport is being played in each of these leagues, (v) for each of these virtual sports leagues, there is a given number of said virtual sports teams who have a season schedule for the playing of a plurality of virtual sporting events that are contested between various pairs of the virtual sports teams in a virtual sports league, (vi) an algorithm for determining the outcome of each of the plurality of virtual sporting events, with these outcomes configured to be dependent upon the actions of the game users when playing this game, and (vii) a user interface on the displays of the game users' computing devices, with this user interface being configured to: (a) register a game user to play the game, (b) provide a sports ID portion for the interface that enables a game user to select from a plurality of sports the one in which the game user chooses to participate, and (c) provide a tier ID portion for the interface that enables a game user to select from a plurality of league tiers the one in which the game user chooses to participate.

Finally, yet another obvious variant of the present invention is a non-transitory, computer-readable medium storing instructions thereon that provide a virtual sports league game to a plurality of game users, each having a networked computing device with a display that is used to play this game over a network, and wherein the instructions on this medium, when executed on a networked server's processor, yields the same sort of creations for the game as those of the software described in the prior paragraph.

Thus, there has been summarized above (rather broadly and understanding that there are other versions of the preferred embodiment which have not been summarized above) the present invention in order that the detailed description that follows may be better understood and appreciated.

### BRIEF DESCRIPTION OF THE DRAWINGS

FIG. 1 is an illustrative, box diagram of a preferred embodiment of the present invention.

FIG. 2 is a general overview of how virtual sports participants are created by the present invention.

FIG. 3 is a general overview of how, in the present invention, virtual sports agents participate in an auction to select which sports participants they'd like to buy and/or represent.

FIG. 4 is a general overview of how an auction process is used by the present invention to create the various, virtual sports teams that will compete against one another in a virtual, sports league.

FIG. 5 is a general overview of how a tiered set of leagues is utilized by the present invention.

FIG. 6 is a screen shot of an example of a game interface that is presented by the present invention to a game user to give the game user an introductory or overview of the various sports, levels of league play, current deals in the marketplace, and upcoming events, etc. in which the game user may participate.

FIG. 7 shows a screen shot or user interface that lists all of the upcoming events which match the game user's sport and tier choices and in which the game user may participate.

FIG. 8 shows a screen shot or user interface that provides both the site where a selected upcoming sports competition will be contested and where it can be watched and a wagering portion that has the status of the wagering to date on this upcoming event.

FIG. 9 shows a screen shot or user interface that is presented to a user who has decided to participate in an upcoming event in the role of a manager and it is meant to assist him/her in picking a lineup for an upcoming event.

FIG. 10 shows a screen shot or user interface that is presented to a user who has decided to participate in an upcoming event in the role of an agent and it is meant to give the agent an overview of the current player marketplace.

FIG. 11 shows a screen shot or user interface that is presented to a user who has decided to participate in an upcoming event in the role of an agent and it is meant to assist the agent in the situation of an initial player auction.

FIG. 12 shows a screen shot or user interface that is presented to a user who has decided to participate in an upcoming event in the role of an agent and it is meant to assist the agent in managing a player that the agent owns.

FIG. 13 shows a screen shot or user interface that is presented to a user who has decided to participate in an upcoming event in the role of an agent and it is meant to be helpful in allowing a contacting agent to contact another agent when the contacting agent wishes to initiate a dialogue that will possibly result in the contacting agent buying a specific player from the agent who currently owns the player.

FIG. 14 shows a screen shot or user interface that is presented to a user who has decided to participate in an upcoming event in the role of an owner and it is meant to assist the owner in buying teams that are currently listed as being for sale.

FIG. 15 shows a screen shot or user interface that is presented to a user who has decided to participate in an upcoming event in the role of an owner and it is meant to assist the owner in buying players that are currently listed as being for sale.

### DESCRIPTION OF THE PREFERRED EMBODIMENT

Before explaining at least one embodiment of the present invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

Various aspects, advantages, features and embodiments are included in the following description of exemplary examples thereof, which description should be taken in conjunction with the accompanying drawings. All patents, patent applications, articles, other publications, documents and things referenced herein are hereby incorporated herein by this reference in their entirety for all purposes. To the extent of any inconsistency or conflict in the definition or use of terms between any of the incorporated publications, documents or things and the present application, those of the present application shall prevail.

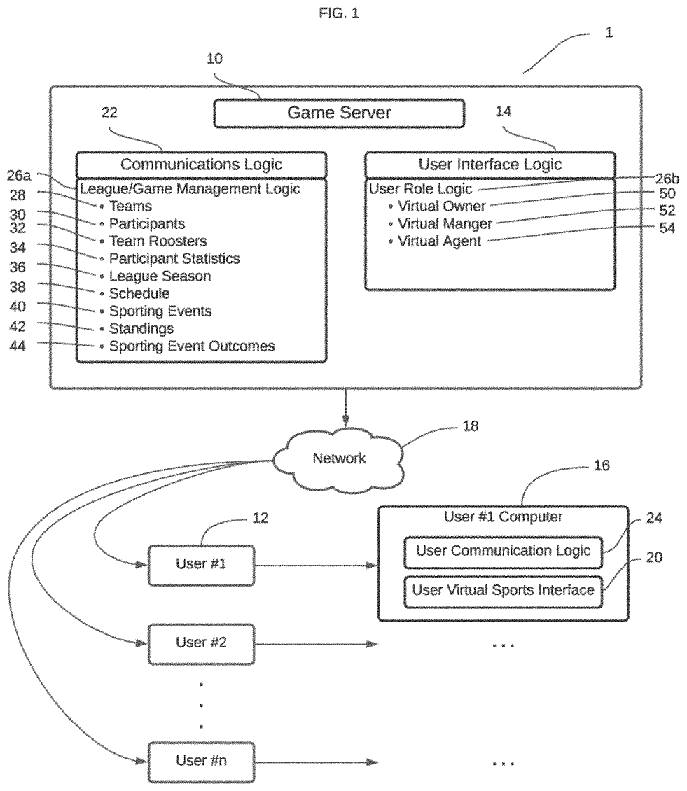

FIG. 1 is an illustrative, box diagram of a preferred embodiment of the present invention 1 in the form of an online fantasy or virtual sports game that provides the opportunity for its game users to participate in any one of a plurality of virtual sports leagues that exist over a hierarchy of levels or tiers (i.e., major and various levels of minor leagues) for any one of a variety of sports (e.g., baseball, football, basketball, soccer). Alternatively, the present invention can also take other forms; such as when an obvious variant of the present invention is considered to be that of a method of simulating, on a computer having a processor, memory, interfaces, ports, display, as well as keyboard and mouse connections, the activities over a virtual sports season of a virtual sports league for a specified sport. Still another obvious variant of the present invention has it taking the form of the many unique, user interfaces that are created for the display of a computer that enables a user to simulate the activities over a virtual sports season of a virtual sports league.

In one aspect, a game server 10, of a computer system configured to manage the entire game (e.g., the server maintains databases, controls and accounts for the various transactions of the game's users or participants), provides a fantasy sports game to be played by one or more users 12. The fantasy sports game may be any online team sports game or competition that is based on, for example, football, baseball, basketball, soccer, cricket, or the like. Even competitions that we don't ordinarily think of as being team competitions, such as horse racing, automobile racing, golf, etc. can be considered as team sports when its realized that the individual competitors often have teams of individuals around them who are tasked with helping them win whatever may be the competitions in which they are participating.

The fantasy sports game of the present invention may be provided by server-based computer program code that executes on the game server. Fantasy sport user interface logic 14 may include, for example, server-based code which provides web-based interface, or the like, to one or more user computers 16 via a network 18, e.g., the Internet. The fantasy or virtual sports user interface 20 is thus generated by, for example, a server page or a downloaded code provided by the fantasy sports user interface logic.

The fantasy sports user interface 20 is, in one aspect, a web-based interface that may include web pages or other user interface features. These may include sports game or league information, game results, and user interface controls, that are displayed to the user on the display of the user's computer. The interface is also configured so as to receive input from the user, e.g., selection of menu items or controls that a user selects or interacts with while playing the sports game.

This fantasy sports user interface provides the interface features through which the user plays the fantasy sports game. This user interface may include screens or other types of user interfaces for presenting information to the user and receiving choices made by the user. For example, there may be interfaces for joining or creating a fantasy or virtual sports league, creating various sports teams, formulating a season schedule of games or events for the various teams in the league, assigning players to the team, removing players from the team, configuring the positions of players on the team, and displaying the outcomes of each of the virtual sports games and the consequences of these outcomes in the form of a continually updated ranking or the standing of the various sports teams compared to each other and based on the won/lost performance of the teams.

Additionally, these interfaces provide for the creation of various roles that a game user may assume while playing the present invention; these roles include, for example, a virtual team manager, a virtual team owner, and a virtual team roster of virtual sport participants that are each represented by a virtual sports agent.

The user's selections in these interfaces are transmitted from the user computer to the server computer via the network. In one aspect, fantasy sports user interface logic on the server generates a fantasy sports user interface, e.g., a web page or a web application, that is transferred from the server to the user via the network.

In one example, server communication logic 22 provides an interface between the fantasy sports user interface logic 14 on the game server 10 and the network 18, e.g., by converting code and data sent to and received from the user computer to a format suitable for transmission on the network. User communication logic 24 provides an interface between the fantasy sports user interface and the network by, for example, receiving and decoding user interface logic and associated data, as well as encoding responses from the user and sending the responses to the server via the network, to be decoded by the server communication logic and presented to the fantasy sports user interface logic, and in turn to game/league management logic 26a and user role logic 26b further processing on the server 10.

Also shown in FIG. 1 are the key outputs or steps or tasks of the present invention's game/league management logic 26a and include creating the following various elements of the virtual sports league: (a) a plurality of virtual sports teams 28 that compete against one another in the virtual sports league, (b) a plurality of virtual sports participants 30, each of whom occupies a position on a roster 32 of participants for each of the virtual sports teams, and wherein each of these virtual sports participants is provided with a participant statistic 34 that serves to define the performance level of the virtual sports participant, (c) a virtual sports league season 36 that includes a schedule 38 for the playing of a plurality of virtual sporting events 40 during the season, and (d) season standings 42 among of the virtual sports teams in the league and whereby these are determined by the season-to-date outcomes 44 of each of the virtual sporting events.

Furthermore, shown in FIG. 1 are also the key outputs or steps or tasks of the present invention's user role logic 26b and include creating the various roles in which a user can function in the herein disclosed virtual sports league. These include, for example: (a) virtual team owner 50, (b) virtual team manager 52, (c) virtual sports agent 54, and (d) virtual spectator 56.

Examples of the kinds of tasks that a game user may undertake in each of these various roles include: (a) virtual team owner: negotiate to buy one of the sports teams and to then negotiate with a virtual sports agent to fill the spots on his/her team roster, (b) virtual team manager: identifies those, from his/her virtual sports team roster, that will represent, including in what capacity or position, the virtual sports team in a specified game or virtual sporting event, and (c) virtual sports agent: negotiate to be retained to provide agent services to one of the plurality of virtual sports participants (in actuality, this task is accomplished with a player auction) and then to negotiate, on behalf of his/her virtual sports participant client to obtain a roster spot for the client.

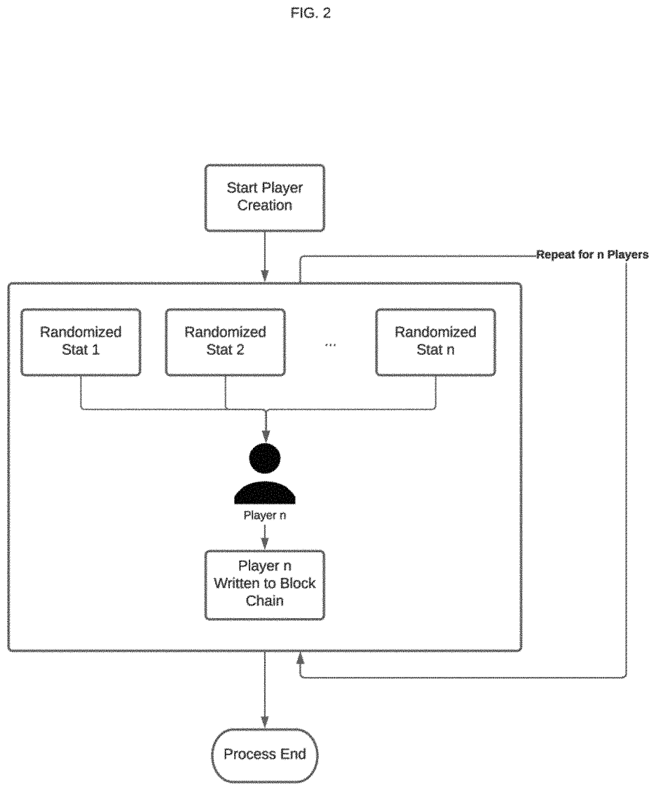

Shown in FIG. 2 is a general outline of how virtual sports participants 30 are created by the present invention. This includes the use of blockchain technology so that the present invention's virtual sports participants, teams, etc. are recorded on a blockchain or a digital ledger of transactions that is duplicated and distributed across the entire network of users computer systems on the blockchain; every time a new transaction occurs on the blockchain, a record of that transaction is added to every user's ledger. Thus, the league's players and teams exist solely on the blockchain and are not tied to real world players or teams.

This virtual sports participant creation process is seen to differ from that used by prior sports fantasy or virtual games in which their sports participants were always tied to something that is happening or has happened in real life (e.g., prior art, sports participants' performances in various, virtual games were based on how an associated, real life player performed in certain games).

For example, in a first embodiment, the virtual sports participants 30 of the present invention are created in sufficient number to fill all the rosters of the virtual sports teams that compete in a specified virtual sports league. The method of creation these participants 30 ensures that they are totally fantasy participants as each of them are made up of N, stochastically generated stats that define the player or participant's “skill” at the time the player is created. Each player's N stats are then used to determine in part how that player will perform in each of the games in which the player participates.

Once these players or virtual sports participants 30 are generated, the activities of the users of the present invention can begin. As previously noted, these activities can involve the user assuming one or more of the various roles (e.g., virtual team owner 50, manager 52, virtual sports agent 54, and virtual spectator 56) available to the user of the present invention.

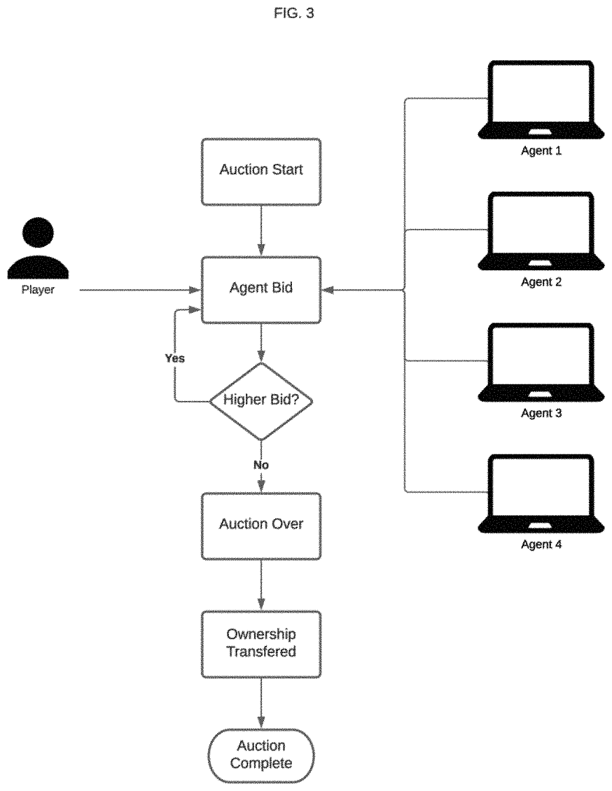

For example, a user performing as a virtual sports agent can begin to select which players he'd like to buy and/or represent. This initial representation or ownership task is usually accomplished through an auction in which competing users, acting temporarily in the roles of agents, bid for those sports participants or players they wish to represent. See FIG. 3.

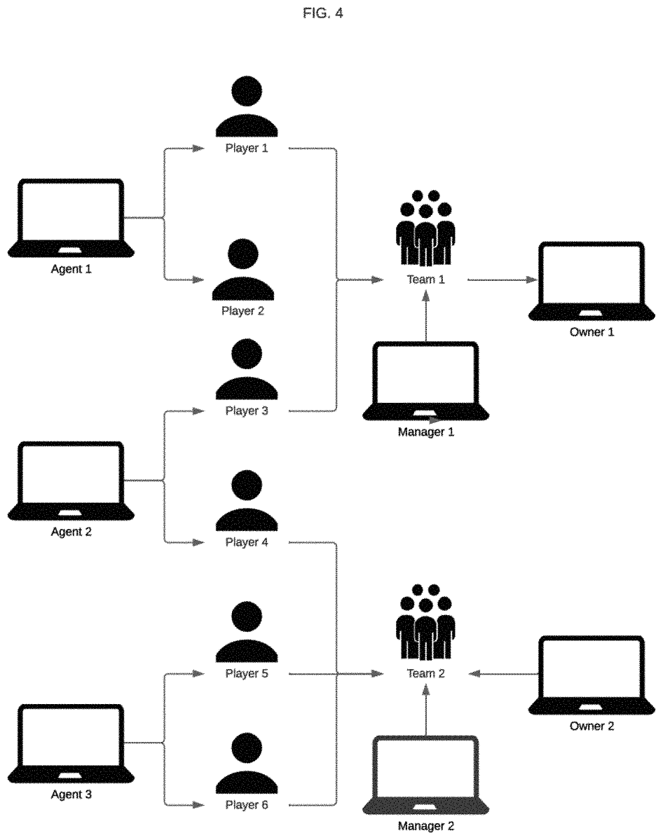

The present invention then uses a similar type of auction process to create the various, virtual sports teams that will compete against one another in the present invention's virtual, sports league. For example, team owners and managers negotiate with the participants sports agents to acquire various, desired participants to fill their team's roster spots. See FIG. 4.

This team creation task again allows competing, game users to perform in multiple roles (e.g., agent, manager & owner). Care must be taken at this stage to ensure that the number of teams that are being created and the allowable number of roster spots for each team do not exceed the number of players that have been created to fill these roster spots.

Other considerations in establishing a league's number of teams are various, seasonal, scheduling issues. The expectation is that there would be a per season cap on the number of competing teams.

After the end of each season, new players are created. Because we′d generally like to hold constant the number of teams in the league from one season to the next, it is necessary to have a means for also holding constant the number of players in the league. To accomplish this, the present invention generally requires the N stats that define each of the players to essentially age or diminish from one season to the next.

For example, if the sport is baseball and a player had at creation one of his N stats that related to his hitting proficiency and it had a value of 10 (on a scale of 1-10, with 10 being the highest), then in his seasons 8-13 his proficiency could be defined to decrease by one unit each season. Then, his proficiency in his 13^{th} season would be a value of 4 and such a level proficiency could effectively mean that this player would have to retire from the league in order to make room for one of the newly created players.

However, the game also provides an option that allows a player's virtual sports agent, who essentially owns the player, to try to forestall, for select players, this diminishment of player skills or productivity with age. This is accomplished by enabling agents to offer their clients/players access to some sort of off-season, specialized training.

The actions of a virtual sports agents in providing for this off-season, specialized training can take many forms. For example, (a) arranging some type of mini-games, etc. for their clients, (b) acquiring some type of token, enhancer, etc. for a specific client that will likely give the client a boost in his/her performance in an upcoming season of games, and (c) paying for specialized trainers to work with or train the client during an off-season.

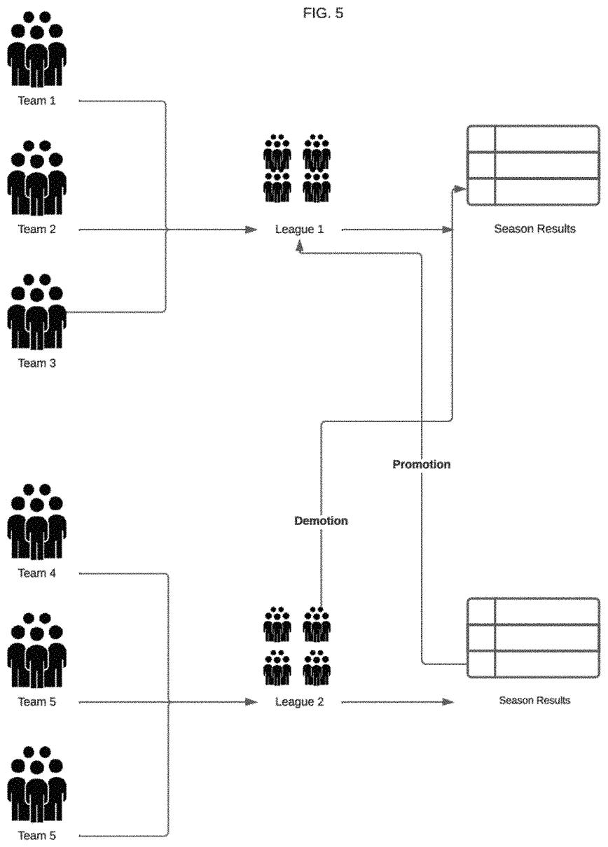

For those players whose skills do diminish with age, retirement from a league does not necessarily have to equate with retirement from a player's sport. The reason for this is that the present invention also allows for the creation of a tiered set of leagues, e.g., a major league, a minor league—Triple A level of the sport, a minor league—Double A level of the sport, etc. See FIG. 5.

Such various, tiered levels of leagues also have the advantage of creating many more roles for a user of the present invention to fill. For example, a user could start as a Double A level team owner and develop his team ownership skills while striving to have his/her team be sufficiently successful in its league play that it would finish near the top of its league's standings and be awarded promotion to the next higher league (e.g., from Double A to Triple A). Furthermore, these lower tiered levels of leagues provide the opportunities for game users to buy lower cost teams, players, etc.

Meanwhile, to keep the number of teams in a league constant, if teams are going to be allowed to rise to the next-higher league based on their winning performance, the present invention will allow the lesser performing teams in a league (i.e., those at the bottom of the league's year-end standings) to be relegated to the next lower league.

The teams in each league play a full season's schedule of games among themselves and the game results or outcomes are stochastically generated using an algorithm that is based on the stats of the individual participants who were selected by the team manager to represent the team in the specific game, and the many actions of the game users while they are playing a specific game and also possibly some of the game users' actions that preceded a specific game or even a full season of games.

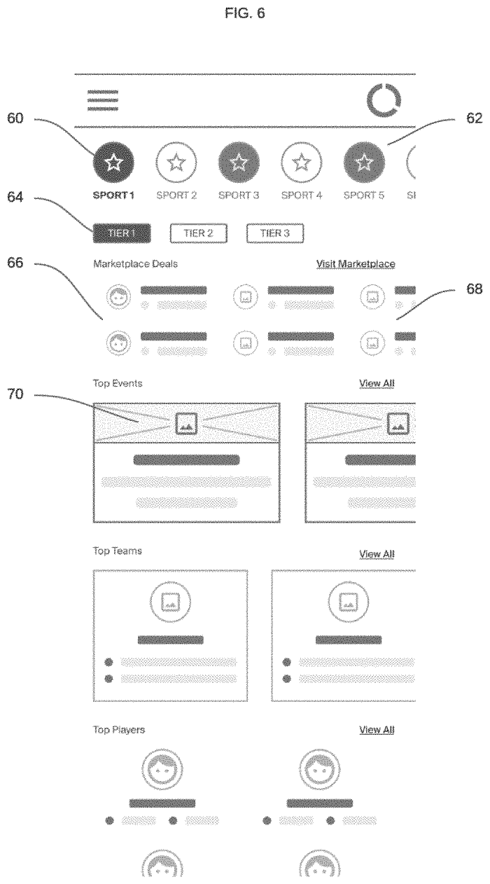

Shown in FIG. 6 is a screen shot of an example of a game interface that is presented by the present invention to a game user to give the game user an introductory or overview of the various sports, levels of league play, current deals in the marketplace, and upcoming events, etc. in which the game user may participate. It can be seen to consist of various portions, including: (a) a sports ID portion 60 that runs horizontally across the top of the screen and uses various numbered icons 62 to identify for the game user the various sports in which he/she may choose to participate by clicking on the appropriate icon, (b) a tier ID portion 64 that runs horizontally near the top of the screen and uses various numbered icons to identify for the game user the various tiers (e.g., major or minor leagues) in which he/she may choose to participate by clicking on the appropriate icon.

After the game user selects his/her sport and its tier ID, this same user interface than shows: (c) a player marketplace portion 66 that indicates, for the game user, examples of some sport participants or players that are currently available and for sale, (d) a team marketplace portion 68 that indicates, for the game user, examples of some sport teams for whom there are currently available portion of these teams for sale, (e) an upcoming events portion 70 that indicates, for the game user, examples of some fantasy sports competitions in which the game user may wish to participate, and (f) an upcoming event informational portion 72 that indicates, for the game user, information regarding the top teams and players that are expected to participate in a specific upcoming event that the game user is interested in participating.

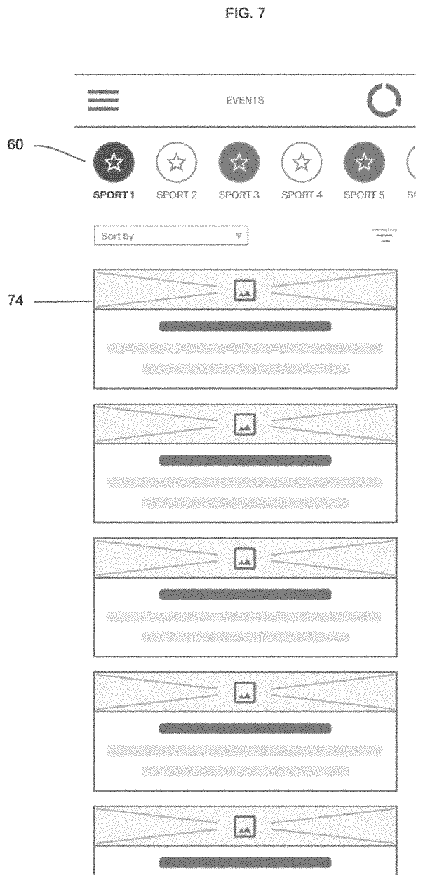

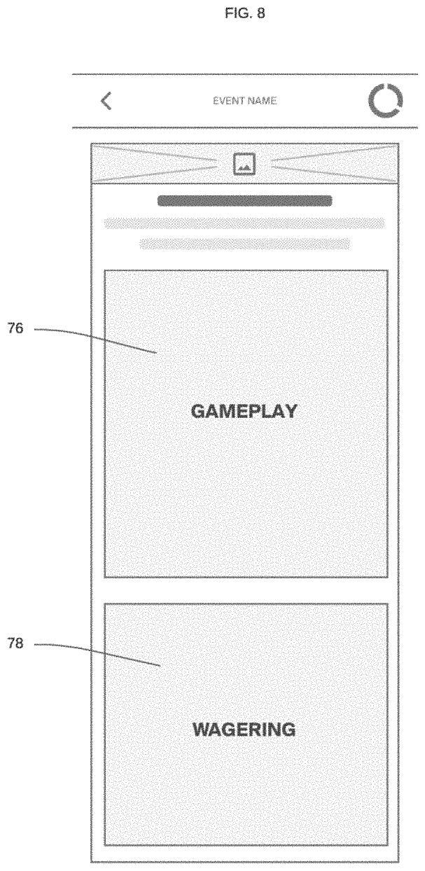

FIGS. 7 and 8 show other examples of screen shots or user interfaces that are presented by the present invention to a game user to provide additional, introductory information or help for the game user in deciding whether he/she might wish to participate in any one of the number of upcoming events of the sport of the game user's choice and at the level of play or tier selected by the game user. The user interface of FIG. 7 is seen to have an event listing portion 74 that lists all of the upcoming events which match the game user's sport and tier choices and in which the game user may participate. Meanwhile, the user interface of FIG. 8 is seen to have both an event watching portion 76 that shows the surface where the selected upcoming sports competition or event will be contested and where the subsequent event can be watched and a wagering portion 78 that shows the status of the wagering to date on this upcoming sporting event.

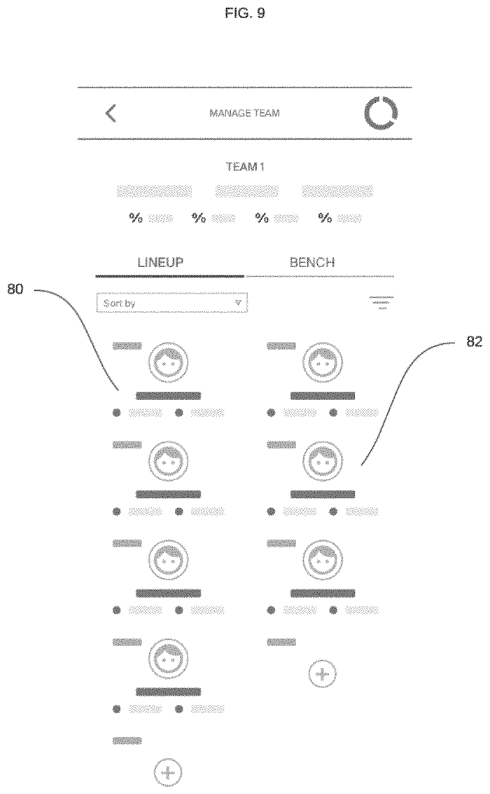

FIG. 9 shows an example of a screen shot or user interface that is presented by the present invention to a game user after that user has decided that he/she wants to participate in an upcoming event or game in the role of a manager. This interface is meant to assist a manager in picking his lineup for an upcoming game or event. It is seen to have a line-up or line-up-in-progress portion 80 that list the players the manger has initially decided to include in his/her starting lineup. It also has a bench portion 82 that list the players on the team's roster who have not yet been chosen for the starting lineup. Selecting or hi-lighting one of these plyers on the bench and hitting the add button on the interface will add this player to the starting lineup.

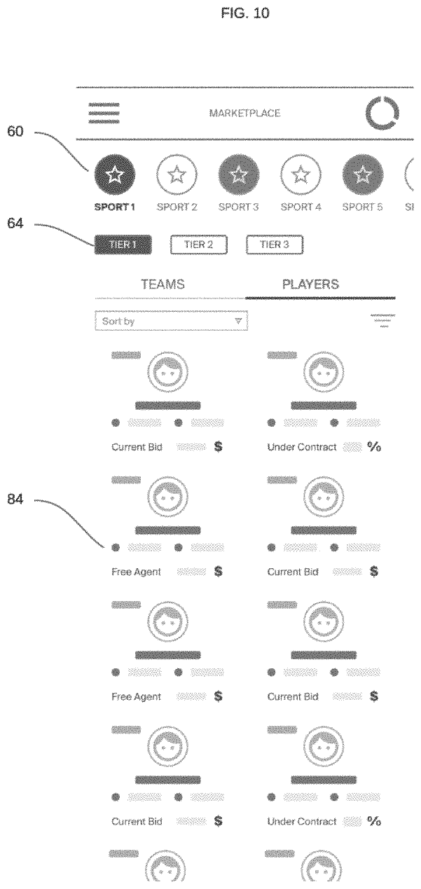

FIGS. 10-13 show examples of screen shots or user interfaces that are presented by the present invention to a game user after that user has decided that he/she wants to participate in an upcoming event, game or sports season in the role of a sports agent. The user interface of FIG. 10 is seen to have the previously mention sports ID and tier ID 64 portions. It is also seen to have a player acquisition status portion 84 that identifies for an agent all the players that are currently for sale and provides some information about the various players' contract statuses (e.g., is their a contract in place that must be bought out or is the player a free agent, have their been recent bids for the player)

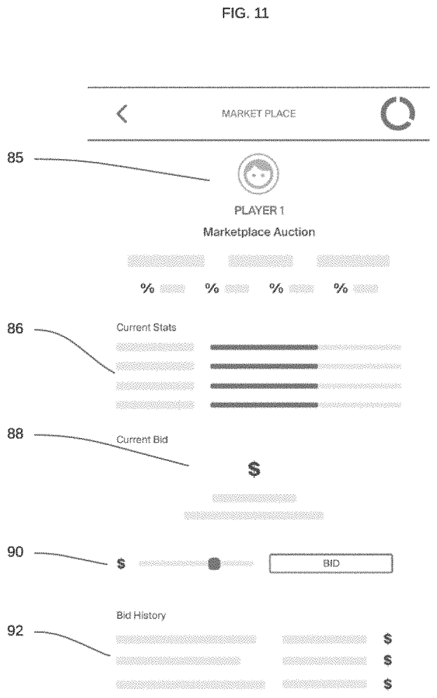

The user interface of FIG. 11 is meant to assist an agent in the situation of an initial player auction. It is seen to have background information for a specific player in the auction. This includes the portions of: a player identification portion 85 that specifically identifies the player that is being auctioned (e.g., name, age, team affiliation), and a player current stats portion 86 that provides statistics which one can use to assess the current performance level of the player. It also has the additional portions of: (a) a current bid portion 88 that shows the current price that has been bid for the player, (b) a bid portion 90 where the agent can enter any amount that the agent might wish to bid for the player and then push a “bid” button to formally submit this bid, and (c) a bid history portion 92 that lists the prior bids that have been made for this player and which have brought the bidding to its current level.

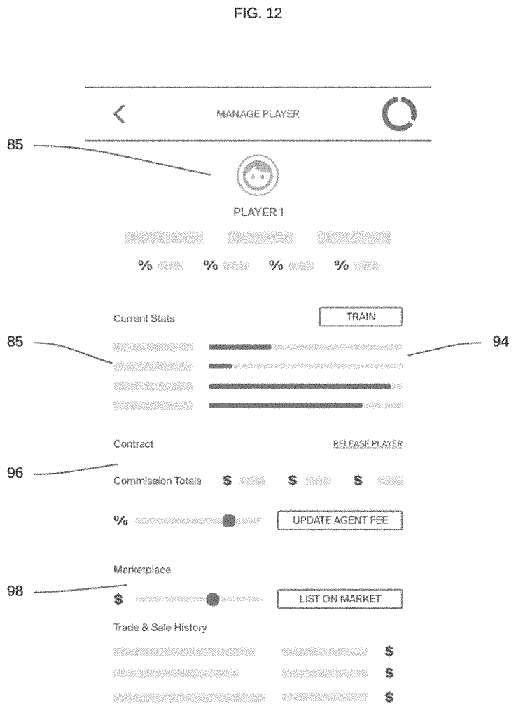

The user interface of FIG. 12 is meant to assist an agent in managing a player that the agent owns. It is seen to have player identification 85 and player current stats 86 portions. It also has the additional portions of: (a) a training portion 94 that lists the various training programs which the player is currently following and which were assigned or authorized by the player's agent in order to enhance his/her performance and market value, (b) a contract portion 96 which summarizes the various financial aspects of both the team and the agent's current contracts with the player (e.g., the player's annual salary for each of the remaining years on the player's contract, the agent's annual percentage fee, the agent's expected annual commission or fee for each of the remaining years on the player's contract), and (c) a player marketplace portion 98 that provides an estimate of the player's current value in his/her marketplace and also shows the player's trade and sales or contract value histories that have contributed to the player being valued at his/her current market value. There also exist a List button to allow the agent to formally list this player as being currently for sale.

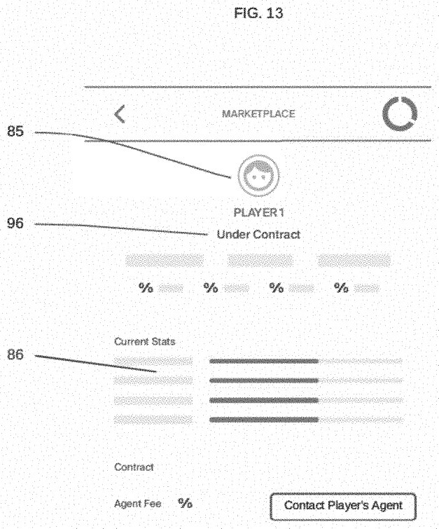

A final example of a user interface of the present invention that is intended for an agent's use is shown in FIG. 13. This interface is meant to be helpful in allowing a contacting agent to contact another agent when the contacting agent wishes to initiate a dialogue that will possibly result in the contacting agent buying a specific player from the agent who currently owns the player. It is seen to have the previously mentioned player identification 85 and player current stats 86 portions. It is also seen to seen to have a variation of the previously mentioned contract 96 portion that specially lists the player's annual salary for each of the remaining years on the player's contract and his current agent's expected percentage fee for each of these years. It also has a Contact Player's Agent button that a contacting agent can use to be placed in contact with the player's current agent for the purpose of initiating a dialogue that will possibly result in the contacting agent buying the player.

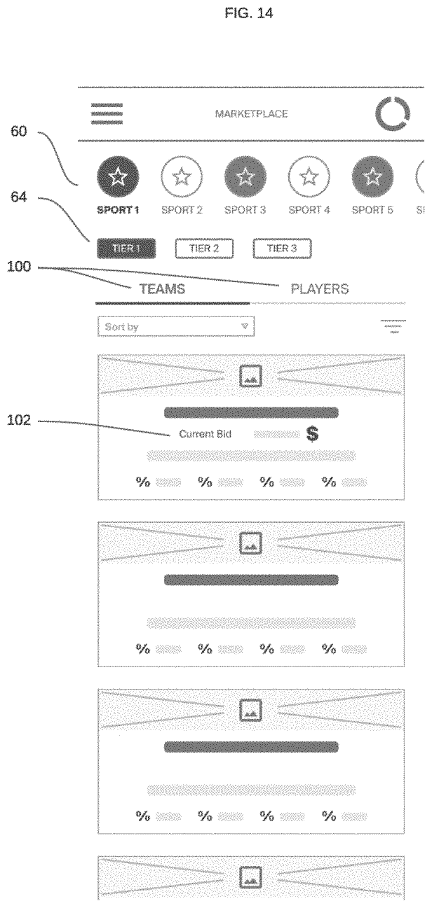

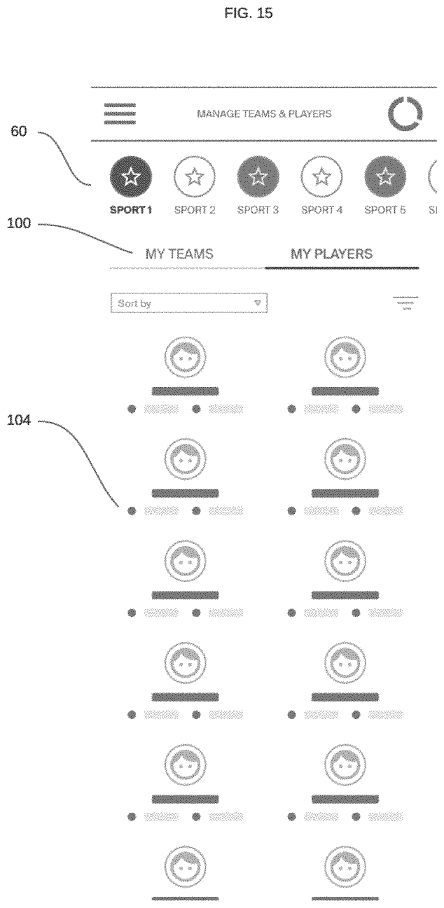

FIGS. 14-15 show examples of screen shots or user interfaces that are presented by the present invention to a game user after that user has decided that he/she wants to participate in an upcoming event, game or sports season in the role of a team owner. The user interface of FIG. 14 is seen to have the previously mentioned selectable, sports ID 60 and tier ID 64 portions. Once these selections have been made, and the owner has used the interface's team/player buttons 100 to made a selection of whether he/she is interested in buying teams or players, if the owner has expressed an interest in buying teams, the bottom of the interface is populated with a team marketplace portion 102 that shows a summary of the information for each of those individual teams that are currently listed as being for sale (e.g., identity of the team, its season won-lost or equivalent season performance record to date, its offered sales price, estimated value of the team, the most current bid price for the team).

FIG. 15 illustrates what the bottom of this interface shows when the owner has used the interface's team/player selection buttons 100 to made a selection which indicates that he/she is interested in buying players. It this situation a player marketplace portion 104 is provided that shows a summary of the information for each of those individual players that are currently listed as being for sale (e.g., identity of the player, his/her current stats, his/her offered sales price, estimated value of the player, the most current bid price for the player).

The foregoing is considered as illustrative only of the principles of the present invention. Further, since numerous modifications and changes will readily occur to those skilled in the art, it is not desired to limit the invention to the exact construction and operation shown and described herein. Accordingly, all suitable modifications and equivalents may be resorted to, falling within the scope of the invention that is hereafter set forth in the claims to the invention.

We claim:

1. A system for providing a virtual sports league game to a plurality of game users, each having a networked computing device with a display that is used to play said game over a network, said system comprising:
a server that connects to said network and has a processor with memory and software that controls the operation of said processor,
a database that resides in said memory and stores information pertaining to said virtual sports league game,
wherein said software includes directions that create for said virtual sports league game:
(i) a plurality of sports in which a game user may select to compete when playing said game,
(ii) a plurality of virtual sports participants, each of which includes a participant statistic that serves to define the performance level of said virtual sports participant,
(iii) a plurality of virtual sports teams, each of which has a team roster of said virtual sport participants,
(iv) a plurality of virtual sports leagues that are distinguishable by the level or tier at which said selected sport is being played in each of said leagues,
(v) for each of said virtual sports leagues, in which play a given number of said virtual sports teams, a season schedule for the playing of a plurality of virtual sporting events that are contested between various pairs of said virtual sports teams in said virtual sports league, and
(vi) an algorithm for determining the outcome of each of said plurality of virtual sporting events, with said outcomes configured to be dependent upon the actions of said game users in playing said game.

2. The system as recited in claim 1, wherein said software further includes instructions that cause said server to cooperate with each of said computing devices to provide on said display of said computing devices a user interface that is configured to:
(a) register a game user to play said game,
(b) provide a sports ID portion for said interface that enables a game user to select from a plurality of sports the one in which the game user chooses to participate, and
(c) provide a tier ID portion for said interface that enables a game user to select from a plurality of league tiers the one in which the game user chooses to participate.

3. The system as recited in claim 1, wherein said software further includes directions that create for said virtual sports league game:
(vii) a plurality of roles for said game user to fulfill in playing said virtual sports league game, said roles including virtual team owners, virtual team managers and virtual agents for virtual sports participants.

4. The system as recited in claim 2, wherein said software further includes directions that create for said virtual sports league game:
(vii) a plurality of roles for said game user to fulfill in playing said virtual sports league game, said roles including virtual team owners, virtual team managers and virtual agents for virtual sports participants.

5. The system as recited in claim 1, wherein said software further includes directions that create for said virtual sports league game:
(viii) for each of said virtual leagues, a seasonal standing, as of a certain date, for each of said virtual sports teams in said virtual sports league and wherein said seasonal standing is determined by the outcomes, up to said certain date, of each of said virtual sporting events for said virtual league; including the situation when said certain date is at the end of a virtual sports season, and in this situation the seasonal standing of said virtual sports teams is said to be the season-ending standings of said virtual teams in said virtual league, and to thereby identify a virtual champion team for said virtual league.

6. The system as recited in claim 2, wherein said software further includes directions that create for said virtual sports league game:
(viii) for each of said virtual leagues, a seasonal standing, as of a certain date, for each of said virtual sports teams in said virtual sports league and wherein said seasonal standing is determined by the outcomes, up to said certain date, of each of said virtual sporting events for said virtual league; including the situation when said certain date is at the end of a virtual sports season, and in this situation the seasonal standing of said virtual sports teams is said to be the season-ending standings of said virtual teams in said virtual league, and to thereby identify a virtual champion team for said virtual league.

7. The system as recited in claim 1, wherein said software further includes directions that create for said virtual sports league game:
(viii) for each of said virtual leagues, a seasonal standing, as of a certain date, for each of said virtual sports teams in said virtual sports league and wherein said seasonal standing is determined by the outcomes, up to said certain date, of each of said virtual sporting events for said virtual league; including the situation when said certain date is at the end of a virtual sports season, and in this situation the seasonal standing of said virtual sports teams is said to be the season-ending standings of said virtual teams in said virtual league, and to thereby identify a virtual champion team for said virtual league.

8. The system as recited in claim 5, wherein said software further includes directions that create for said virtual sports league game:
(ix) a procedure whereby said season-ending standing is used to enable said league virtual champion team to advance for the upcoming virtual sports season to play in the immediately above, hierarchical ranked, virtual sports league to the one in which said league virtual champion team played during the past virtual sports league season.

9. The system as recited in claim 3, wherein said software further includes directions that create for said virtual sports league game:
(x) a virtual sports participant auction configured to enable a virtual sports agent to acquire the rights to represent one of said virtual sports participants.

10. The system as recited in claim 3, wherein said software further includes directions that create for said virtual sports league game:
(xi) a virtual sports team auction configured to enable a virtual sports team owner to acquire one of said virtual sports teams.

11. The system as recited in claim 2, wherein said user interface is further configured to provide:
(d) a virtual sports participant marketplace portion that indicates the virtual sport participants that are currently available and for sale, and
(e) a virtual sports team marketplace portion that indicates the virtual sport teams that are currently available and for sale.

12. The system as recited in claim 4, wherein said user interface is further configured to provide:
(f) a line-up portion that enables a game user, who is participating in the game in the role of a virtual team manager, to pick a virtual team line-up for an upcoming virtual sporting event.

13. The system as recited in claim 11, wherein said user interface is further configured to provide:
(g) an upcoming, virtual sporting events portion that indicates upcoming virtual sporting events in which a game user may participate.

14. The system as recited in claim 4, wherein said user interface is further configured to provide:
(h) a virtual sports participant management portion that assists a game user, who is participating in the game in the role of a virtual sports agent, to manage a virtual sports participant that is owned by said virtual sports agent.

15. The system as recited in claim 12, wherein said user interface is further configured to provide:
(h) a virtual sports participant management portion that assists a game user, who is participating in the game in the role of a virtual sports agent, to manage a virtual sports participant that is owned by said virtual sports agent.

16. A non-transitory, computer-readable medium storing instructions that provide a virtual sports league game to a plurality of game users, each having a networked computing device with a display that is used to play said game over a network, said instructions on said medium, when executed on a server, having a processor with memory, that is connected to said network, comprising the steps of:
creating for said virtual sports league game:
(i) a plurality of sports in which a game user may select to compete when playing said game,
(ii) a plurality of virtual sports participants, each of which includes a participant statistic that serves to define the performance level of said virtual sports participant,
(iii) a plurality of virtual sports teams, each of which has a team roster of said virtual sport participants,
(iv) a plurality of virtual sports leagues that are distinguishable by the level or tier at which said selected sport is being played in each of said leagues,
(v) for each of said virtual sports leagues, in which play a given number of said virtual sports teams, a season schedule for the playing of a plurality of virtual sporting events that are contested between various pairs of said virtual sports teams in said virtual sports league, and
(vi) an algorithm for determining the outcome of each of said plurality of virtual sporting events, with said outcomes configured to be dependent upon the actions of said game users in playing said game.

17. The non-transitory, computer-readable medium as recited in claim 16, said instructions on said medium further comprising the step of causing said server to cooperate with each of said computing devices to provide on said display of said computing devices a user interface that is configured to:
(a) register a game user to play said game,
(b) provide a sports ID portion for said interface that enables a game user to select from a plurality of sports the one in which the game user chooses to participate, and
(c) provide a tier ID portion for said interface that enables a game user to select from a plurality of league tiers the one in which the game user chooses to participate.

18. The non-transitory, computer-readable medium as recited in claim 16, said instructions on said medium comprising the further step of:
creating for said virtual sports league game:
(vii) a plurality of roles for said game user to fulfill in playing said virtual sports league game, said roles including virtual team owners, virtual team managers and virtual agents for virtual sports participants.

19. The non-transitory, computer-readable medium as recited in claim 17, said instructions on said medium comprising the further step of:
creating for said virtual sports league game:
(vii) a plurality of roles for said game user to fulfill in playing said virtual sports league game, said roles including virtual team owners, virtual team managers and virtual agents for virtual sports participants.

20. The non-transitory, computer-readable medium as recited in claim 16, said instructions on said medium comprising the further step of:
creating for each of said virtual leagues:
(viii) a seasonal standing, as of a certain date, for each of said virtual sports teams in said virtual sports league and wherein said seasonal standing is determined by the outcomes, up to said certain date, of each of said virtual sporting events for said virtual league; including the situation when said certain date is at the end of a virtual sports season, and in this situation the seasonal standing of said virtual sports teams is said to be the season-ending standings of said virtual teams in said virtual league, and to thereby identify a virtual champion team for said virtual league.

21. The non-transitory, computer-readable medium as recited in claim 17, said instructions on said medium comprising the further step of:
creating for each of said virtual leagues:
(viii) a seasonal standing, as of a certain date, for each of said virtual sports teams in said virtual sports league and wherein said seasonal standing is determined by the outcomes, up to said certain date, of each of said virtual sporting events for said virtual league; including the situation when said certain date is at the end of a virtual sports season, and in this situation the seasonal standing of said virtual sports teams is said to be the season-ending standings of said virtual teams in said virtual league, and to thereby identify a virtual champion team for said virtual league.

22. The non-transitory, computer-readable medium as recited in claim 18, said instructions on said medium comprising the further step of:
creating for each of said virtual leagues:
(viii) a seasonal standing, as of a certain date, for each of said virtual sports teams in said virtual sports league and wherein said seasonal standing is determined by the outcomes, up to said certain date, of each of said virtual sporting events for said virtual league; including the situation when said certain date is at the end of a virtual sports season, and in this situation the seasonal standing of said virtual sports teams is said to be the season-ending standings of said virtual teams in said virtual league, and to thereby identify a virtual champion team for said virtual league.

23. The non-transitory, computer-readable medium as recited in claim 20, said instructions on said medium comprising the further step of:
creating for said virtual sports league game:
(ix) a procedure whereby said season-ending standing is used to enable said league virtual champion team to advance for the upcoming virtual sports season to play in the immediately above, hierarchical ranked, virtual sports league to the one in which said league virtual champion team played during the past virtual sports league season.

24. The non-transitory, computer-readable medium as recited in claim 18, said instructions on said medium comprising the further step of:
creating for said virtual sports league game:
(x) a virtual sports participant auction configured to enable a virtual sports agent to acquire the rights to represent one of said virtual sports participants.

25. The non-transitory, computer-readable medium as recited in claim 19, said instructions on said medium comprising the further step of:
creating for said virtual sports league game:
(xi) a virtual sports team auction configured to enable a virtual sports team owner to acquire one of said virtual sports teams.

26. The non-transitory, computer-readable medium as recited in claim 17, said instructions on said medium comprising the step of causing said user interface to further provide:
(d) a virtual sports participant marketplace portion that indicates the virtual sport participants that are currently available and for sale, and
(e) a virtual sports team marketplace portion that indicates the virtual sport teams that are currently available and for sale.

27. The non-transitory, computer-readable medium as recited in claim 19, said instructions on said medium comprising the step of causing said user interface to further provide:
(f) a line-up portion that enables a game user, who is participating in the game in the role of a virtual team manager, to pick a virtual team line-up for an upcoming virtual sporting event.

28. The non-transitory, computer-readable medium as recited in claim 26, said instructions on said medium comprising the step of causing said user interface to further provide:
(g) an upcoming, virtual sporting events portion that indicates upcoming virtual sporting events in which a game user may participate.

29. The non-transitory, computer-readable medium as recited in claim 19, said instructions on said medium comprising the step of causing said user interface to further provide:
(h) a virtual sports participant management portion that assists a game user, who is participating in the game in the role of a virtual sports agent, to manage a virtual sports participant that is owned by said virtual sports agent.

30. The non-transitory, computer-readable medium as recited in claim 27, said instructions on said medium comprising the step of causing said user interface to further provide:
(h) a virtual sports participant management portion that assists a game user, who is participating in the game in the role of a virtual sports agent, to manage a virtual sports participant that is owned by said virtual sports agent.
